(19) United States
(12) Patent Application Publication
(10) Pub. No.: US 2017/0193192 A1
(43) Pub. Date: Jul. 6, 2017

(54) METHODS AND SYSTEM FOR ASSESSING FORM TO FORM COMPATIBILITY OF THERAPEUTIC AGENTS IN CLINICAL ENVIRONMENTS

(71) Applicant: CERNER INNOVATION, INC., KANSAS CITY, KS (US)

(72) Inventors: ARBIND KUMAR CHOUBEY, BANGALORE (IN); BRETT AARON BARKER, OLATHE, KS (US); DEEPAK GUPTA, BANGALORE (IN); LISA MARIE SMITH, LENEXA, KS (US); LISA ANN WIEDEMANN, OVERLAND PARK, KS (US); PIYUSH KUMAR, BANGALORE (IN); SCOTT ALAN JULIUS, RAYMORE, MO (US)

(21) Appl. No.: 15/059,990

(22) Filed: Mar. 3, 2016

(30) Foreign Application Priority Data
Dec. 30, 2015 (IN) 4319-DEL-2015

(51) Int. Cl. G06F 19/00; G06Q 10/06

(52) U.S. Cl. CPC G06F 19/3475; G06Q 10/0633

(57) ABSTRACT

Methods and systems are provided for assessing compatibility between forms of medication in a clinical setting. Generally, a medical order for a patient is received, which specifies a task with an initial form of a medical agent to be administered to the patient. When a clinician attempts to administer the medical agent to the patient, a current form of the medical agent is received from a scanning device, for example. As such, it may be determined whether the current form is compatible with the initial form. When it is determined that the current form is not compatible with the initial form, an error may be generated and issued in an effort to prevent administration of the current form to the patient.

### CROSS-REFERENCE TO RELATED APPLICATIONS

This application filed at the United States Patent and Trademark Office claims a priority benefit under 35 U.S.C. §119 to co-pending Indian Provisional Application No. 4319-DEL-2015, filed in India on 30 Dec. 2015 and entitled “Methods and System for Assessing Form to Form Compatibility of Therapeutic Agents in Clinical Environment” the entirety of which is incorporated by reference herein.

### BACKGROUND

Emerging use of technology and devices to monitor and track the movement of therapeutic agents through the clinician workflow and to the points of care to patients has created new, technology-specific difficulties. More particularly, when a clinician seeks to perform a patient care task (e.g., administration of a therapeutic agent such as medication), the form (e.g., tablet) of a therapeutic agent at the point of administration to a patient may not be a complete or true match to a form of the therapeutic agent that was initially assigned or selected for the therapeutic agent at the time the patient care task was generated for a medical order. As such, the technology and devices used to monitor and track the therapeutic agent may issue an error to the clinician when the clinician attempts to electronically log or electronically document the performance and completion of the patient care task. Such an error may be issued because the form of the therapeutic agent to be administered to the patient is not an exact match to the form of the therapeutic agent as initially entered into the workflow for the medical order, including patient care tasks generated therein. When such an error issues, the clinician is forced to manually log or manually document the administration of the therapeutic agent. Manual documentation negatively impacts performance indicators of the clinician regarding technology-based tracking systems (e.g., barcode scanning), negatively impacts performance indicators for the hospital's compliance with technology-based tracking system implementations, and may negatively impact the safety and care of a patient as adverse medication interactions, scheduling conflicts, dosing errors, medication duplications, medication omissions, and other safety checks are not performed due to the lack of being triggered by the technology-based tracking system. Although at least some of these problems are apparent, an effective solution has not been proposed or implemented, as set forth hereinafter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-readable media for assessing form to form compatibility of therapeutic agents in clinical environments. Generally, when a clinician seeks to perform a patient care task, the form (e.g., tablet) of a therapeutic agent at the point of administration to a patient may not be a complete or true match to a form of the therapeutic agent that was previously determined for the corresponding medical order, selected for the corresponding medical order, and/or automatically assigned at the time the patient care task was generated for the corresponding medical order. However, some forms, while not exact or true matches, are clinically compatible such that one form may be safely substituted for another form by a clinician with minimal or negligible differences in patient care. In embodiments presented herein, compatible forms of the therapeutic agent may be automatically identified, thus preventing the issuance of an error for mismatched but compatible forms when the clinician attempts to electronically chart the performance of the patient care task. Accordingly, for example, the negligible difference between a Tylenol caplet and a Tylenol tablet no longer grinds the workflow of patient care to halt, but rather, the clinician may proceed to electronically document the patient care task using scanning solutions.

### BRIEF DESCRIPTION OF THE DRAWINGS

Embodiments are described in detail below with reference to the attached drawing figures, wherein:

FIG. 1 is a block diagram of an exemplary computing system suitable to implement embodiments of the present invention;

FIG. 2 is a block diagram of an exemplary healthcare information and management system suitable for assessing form to form compatibility in accordance with an embodiment of the present invention;

FIG. 3 is a flow diagram showing a method for assessing form to form compatibility; and

FIG. 4 is a diagram showing component interactions in a healthcare information and management system in accordance with an embodiment of the present invention.

### DETAILED DESCRIPTION

The subject matter of the present invention is described with specificity herein to meet statutory requirements. However, the Description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. In the same vein, the claimed subject matter might also be embodied in other ways, to include different components or combinations of components, similar to those described in this document, in conjunction with other present or future technologies.

As will be described, a healthcare worker uses a technological tracking solution and various computing devices to track the movement of therapeutic agents through a workflow. Exemplary technological tracking solutions include scanning solutions such as Bridge Medical Administration®, for example. A therapeutic agent refers to an agent having beneficial therapeutic properties and/or effects such as a medication, a prescription drug, an intravenous solution, an antibiotic, a retroviral agent, a radioactive agent, a vitamin or supplement, an analgesic, a steroid, a chemotherapy agent, and the like. The terms “medical agent” and “therapeutic agent” are used interchangeably herein.

At various points, different healthcare workers use computing devices and scanning devices (e.g., a barcode scanner, an RFID tag reader) in a distributed healthcare information and management system to track the therapeutic agent when entered into the healthcare information and management system as part of a medical order from a clinician. A medical order refers to a task to be performed by a healthcare worker for a patient. An exemplary medical order may include, as entered by or on behalf of an epileptologist, direct a charge nurse to administer 750 mg of levetiracetam in a tablet form orally, twice a day to patient A. Accordingly, a medical order may include a prescription for a specific therapeutic agent as well as instructions (e.g., dosage, route of administration) regarding delivery or administration of the therapeutic agent to a specified patient. Alternatively, it will be understood that a medical order might include instructions to stop, taper, and/or withdrawal of a therapeutic agent.

However, the technological tracking solution employed may result in errors and create hurdles along the workflow of the healthcare information and management system. For example, when a healthcare worker (e.g., a clinician) attempts to complete a task in the workflow, a scanning device may register that a tablet form of a therapeutic agent is to be administered to a patient when the task, as initially populated into the workflow, was associated with a caplet form of the therapeutic agent. Thus, the tablet form may register as different (in form) than the caplet form. In such an example, the mismatch of one form to another form of the same therapeutic agent results in an error in the workflow of the healthcare information and management system. Even though the tablet form may be as safe and effective as the caplet form, the workflow grinds to a halt due to the mismatch of forms of the therapeutic agent. In this regard, the tablet form may be compatible with regard to the caplet form, such that any differences resulting due to administering the tablet form instead of the caplet form are negligible in terms of patient care outcomes. The error may prevent a healthcare worker from electronically documenting completion of the task in the workflow such that the healthcare worker has to manually document completion of the task. And the inability to use the electronic documentation may result in detrimentally foregoing built-in safety checks that are typically performed in real time during task completion. Exemplary safety checks may include identifying any potential adverse medication interactions and/or identifying any scheduling conflicts. The failure to employ built-in safety checks invites risking patient safety. Accordingly, technological tracking solutions can actually create hurdles by introducing time inefficiencies and failure to perform safety checks instead of streamlining patient care. These problems may be caused due to errors forced by mismatched forms of therapeutic agents in the workflow of a healthcare information and management system. However, the present invention automatically identifies compatibility between different forms of a therapeutic agent so as to avoid errors and streamline patient care.

Mismatched forms, as addressed by the present invention, may result from a difference in forms at the point of administration and as previously assigned to the medical order in the workflow. Regarding the workflow, a clinician may enter a medical order into a healthcare information and management system. The entry of the medical order generally results in the generation of a workflow that includes one or more tasks to be performed by various healthcare workers. For example, the workflow includes one or more tasks, each task to be performed by a delegated healthcare worker. For example, a task for a pharmacist to assign and fill a prescription for a therapeutic agent is generated and used to populate the workflow. A task may be generated and populated into the workflow, wherein the task that directs a healthcare staffer to transport the filled prescription from the pharmacy department of a hospital, for example, to a specified patient floor wherein a patient is staying, as admitted. Additionally, a task for a floor nurse to administer the filled prescription to the patient staying on the specified patient floor at a particular date and time may be populated into the workflow previously, simultaneously, or concurrently. Thus, each healthcare worker, including the clinician, pharmacist, staffer, and floor nurse, may use one or more computing devices to access a list of tasks that is specific to each healthcare worker as populated into the workflow in response to receipt of the medical order. It will be understood that the tasks may be populated into the workflow at any time. In some embodiments, tasks may be communicated to a healthcare worker after the completion of another task as performed by a different healthcare worker. As such, tasks may be populated into the workflow but communicated later, for example, in a sequence. For example, a task directing a floor nurse to administer a medication to a patient may not be communicated to the floor nurse unless and/or until the workflow registers that a pharmacist has filled a prescription corresponding to the medication. However, both tasks may have been concurrently populated into the workflow. Thus, different tasks in the workflow may be associated with different forms of a therapeutic agent. A form may be associated with the tasks at time the task is populated into the workflow; however, actual performance of the task by a clinician may report or indicate a different form, thereby resulting in a warning or error. However, the present invention provides for preventing such errors by determining compatibility between different forms of a therapeutic agent.

In a first embodiment, a system useful for assessing compatibility between therapeutic agent forms during medical order task performance in a clinical setting is provided. The system comprises a computer store containing data. And for each of a plurality of therapeutic agents, the computer store containing data includes a compatibility index of one or more forms of each of the plurality of therapeutic agents that are compatible. The system further comprises a computer server in a healthcare information system. The computer server is coupled to the computer store containing data, in embodiments. Further, the computer server is programmed to receive an indication of a task corresponding to a medical order for a patient. In some embodiments, the task specifies a current form of a therapeutic agent for administering to the patient. The computer server is also programmed to identify an initial form previously assigned to the medical order for the patient and to determine whether the current form of the therapeutic agent is compatible with the initial form using the compatibility index. When it is determined that the current form of the therapeutic agent is not compatible with the initial form, the computer server issues an error.

In another embodiment, one or more computer storage media having computer-usable instructions are provided. When the computer-usable instructions of the computer storage media are used by one or more computing devices, the one or more computing devices perform a method for assessing compatibility between therapeutic agent forms during medical order task performance in a clinical setting. The method resulting comprises receiving an indication of a task associated with a medical order for a patient, the indication including a current form of a medical agent for administering to the patient. An initial form that was previously assigned to the medical order for the patient is identified. Then, the method determines whether the current form of the medical agent is compatible with the initial form. When it is determined that the initial form is not compatible with the current form, an error is issued.

In yet another embodiment, a computerized method for assessing compatibility between medical agent forms during medical order task performance in a clinical setting is provided. The method is performed via a computer server in a healthcare information system, in embodiments. At the computer server, the method comprises receiving an indication of a task associated with a medical order for a patient, the indication including a current form of a medical agent for administering to the patient. An initial form that was previously assigned to the medical order for the patient is identified. The method continues by identifying one or more forms that are compatible with the initial form using a compatibility index stored in memory coupled to the computer server. Then, a determination is made as to whether the current form is compatible with the initial form. When it is determined that that the initial form is not compatible with the current form, the method comprises generating an error to be communicated to a remote computing device.

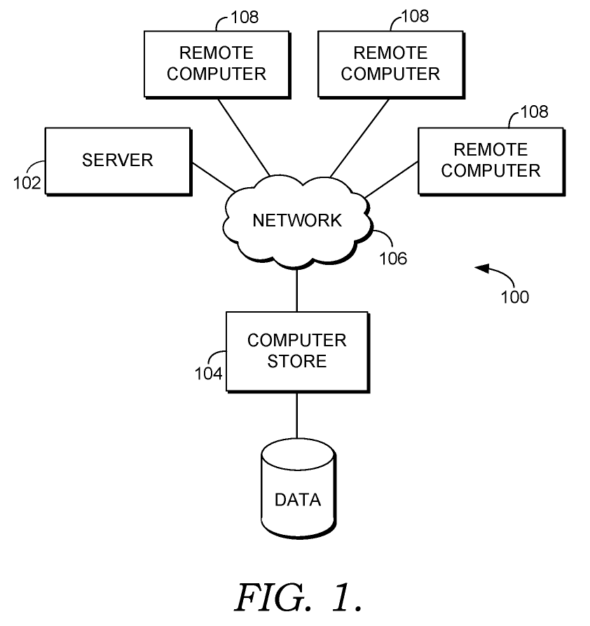

Referring now to the drawings in general, and initially to FIG. 1 in particular, an exemplary computing system environment, for instance, a healthcare information and management system, in which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the healthcare information and management system be interpreted as having any dependency or requirement relating to any single component or combination of components illustrated therein.

The present invention may be operational with numerous other general-purpose or special-purpose computing system environments or configurations. Examples of well-known computing systems, environments, and/or configurations that may be suitable for use with the present invention include, by way of example only, personal computers, server computers, handheld or laptop devices, multiprocessor systems, microprocessor-based systems, set top boxes, programmable consumer electronics, network PCs, minicomputers, mainframe computers, distributed computing environments that include any of the above-mentioned systems or devices, and the like. In embodiments, the present invention may be implemented in computing system environments employed within healthcare facilities, such as a distributed network that communicatively couples multiple, affiliated hospitals and/or related outpatient clinics. For example, computing systems employed for healthcare facility implementation may include, in addition to those examples of well-known computing systems, patient monitoring devices, scanning devices, infusion pumps, ventilators, and the like.

The present invention may be described in the general context of computer-executable instructions, such as program modules, being executed by a computing device. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary healthcare information and management system includes a general-purpose computing device in the form of a computer server, illustrated as server 102. The server 102 may be employed within the healthcare information and management system. Components of the server 102 may include, without limitation, a processing unit, internal system memory, and a suitable system bus for coupling various system components, including a database or database cluster. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer-readable media, for instance, a computer store 104. Computer-readable media can be any available media that may be accessed by server 102, and includes volatile and nonvolatile media, as well as removable and non-removable media. By way of example, and not limitation, computer-readable media may include computer storage media and communication media. Computer storage media may include, without limitation, volatile and nonvolatile media, as well as removable and non-removable media, implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including a computer store 104, provides storage of computer-readable instructions, data structures, program modules, and other data for the server 102. As such, the server 102 may be programmed to perform various tasks using computer-readable instructions, including embodiments of methods described hereinafter. For example, the server 102 may be programmed with one or more modules that facilitate management of specific tasks in a workflow of a healthcare information and management system. Exemplary modules might include a task generation module configured to populate a workflow with one or more tasks in response to receipt of a medical order, and a form assignment module configured to assign an initial form to a therapeutic agent associated with or specified in a medical order. Further exemplary modules might include a form compatibility module configured to identify an initial form assigned to a medical order, determine whether the current form of a therapeutic agent is compatible with an initial form, and when it is determined that the current form of the therapeutic agent is not compatible with the initial form, issue an error. As used herein, “compatible” refers to interchangeability of one form for another, such that patient care outcome is not negatively affected, or such that any difference in patient care outcome due to the difference of two forms is clinically negligible. In further terms, compatible forms may be considered interchangeable and/or acceptable substitutions for one another by clinicians or other users in a clinical setting.

In embodiments, the server 102 is coupled to a computer store 104 such that the server 102 may access, communicate with, and otherwise retrieve information stored by the computer store 104. In embodiments, the computer store 104 is a database configured to store information encoded as data. In some embodiments, the computer store 104 is configured to permanently store data such as electronic medical records for a plurality of patients. As such, the computer store 104 includes memory. In another embodiment, the computer store 104 is configured to temporarily store data, such that the computer store 104 may act, at least partially, as a cache for faster data access and retrieval by the server 102. Additionally or alternatively, the computer store 104 includes long-term permanent data storage for storing one or more electronic medical records (EMR) of patients associated with a medical entity (e.g., hospital, group of hospitals, physicians group, an outpatient clinic). In embodiments, the computer store 104 includes computer-readable media, as previously described hereinabove. In further embodiments, the computer store 104 may comprise a form compatibility database that is configured to store a compatibility index of one or more forms for each of a plurality of therapeutic agents, for example.

The server 102 may operate in a distributed network environment 106 of the healthcare information and management system 100. The server 102 and the distributed network environment 106 use logical connections to communicate with one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; genetic counselors; researchers; veterinarians; students; and the like. The remote computers 108 may also be physically located in non-traditional healthcare environments so that the entire healthcare community may be capable of integration with the distributed network environment 106.

The remote computers 108 may include a handheld device or mobile device, in some embodiments. The remote computers 108 may include, incorporate, and/or be coupled to a scanning device, such as barcode scanners, radio frequency identification (RFID) reading devices, or real-time locating system (RTLS) devices, for example. Scanning devices may be handheld devices, in some embodiments. As such, remote computer 108 may be a scanning device configured to read machine-readable identifiers that encode information which is used to specifically and/or uniquely identify a healthcare worker, a patient, a medical device, and a therapeutic agent associated with a medical order. The remote computer 108 including a scanning device may be used to electronically document the completion of workflow tasks within a clinical setting when said scanning device is used to identify and track healthcare workers, patients, medical devices, and therapeutic agents within the clinical setting, as associated with workflow tasks. Exemplary remote computer 108 may include personal computers, servers, routers, network PCs, peer devices, other common network nodes, or the like, and may include some or all of the components described above in relation to the server 102. The devices may be personal digital assistants or other like devices, in some embodiments.

Continuing, exemplary distributed network environment 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the computer store 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

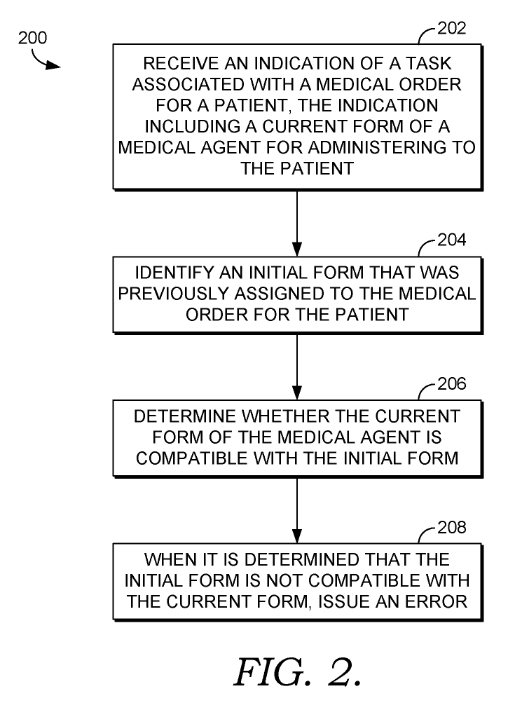

Turning to FIG. 2, a flow diagram is provided illustrating a method 200 for assessing compatibility between therapeutic agent forms during medical order task performance in a clinical setting, in accordance with an embodiment of the present invention. In some embodiments, the method 200 may be performed using one or more computer storage media, such as previously described. For example, computer storage media may have computer-usable instructions that, when used by one or more computing devices, cause said computing devices to perform the method 200.

At block 202, an indication of a task associated with a medical order for a patient is received. Generally, the indication corresponds to a clinician attempting to perform and/or complete a task corresponding to the medical order. For example, a floor nurse examines a workflow, as previously described hereinabove, that includes tasks to be performed by the floor nurse regarding patients. The floor nurse decides to address one of the tasks in the workflow which corresponds to a medical order. The selection of a task may be based on a variety of factors (e.g., due date of task, scheduled time to complete task, urgency of task, emergent task, chronological order of medical order placement, estimated time needed to complete task). The task may be automatically provided to a clinician in a workflow, or selected manually by a clinician, in embodiments.

Continuing with the example, the floor nurse uses a scanning device to read an identifier (e.g., a barcode) specific to the floor nurse, to read an identifier specific to the patient, and to read an identifier of a medical agent which the floor nurse wishes to administer to the patient, based on the task in the workflow. In this way, the floor nurse electronically documents and/or electronically logs that the floor nurse is attempting to perform and complete the task. In response to the scanning device reading one or more of the identifiers, an indication that the floor nurse is beginning or will perform the task may be communicated to another computing device or a server, for example.

Generally, the task is associated with a medical order. A medical order refers to or includes a task which is populated into the workflow, such that the task is to be performed by a healthcare worker (e.g., clinician). Typically, the medical order is electronically placed or entered into the healthcare information and management system by a clinician using a computing device such that the medical order creates a new workflow and/or is inserted into an existing workflow. In embodiments, the medical order includes a plurality of tasks to be performed by one clinician, or alternatively, to be performed by more than one clinician. In some embodiments, the medical order is a plurality of tasks to be performed by a single clinician for one patient, or alternatively, the medical order is a plurality of tasks to be performed by a single clinician for multiple patients.

In other embodiments, the medical order includes a single task; however, the entry of the medical task into the workflow triggers the automatic addition of other related tasks to the workflow. As such, the workflow may be “populated” with tasks based on the medical order. For example, when a clinician enters a medical order to administer 500 mg of ciprofloxacin in the form of an oral tablet to patient C, the workflow may further be automatically populated with a first task for (i.e., to be performed by) a pharmacist, a second task for a staffer, a third task for a floor nurse, and a fourth task for a lab technician. In such an example, the medical order for ciprofloxacin may automatically populate the workflow with an additional related task that directs a healthcare worker to administer a pregnancy test (where the patient is female), due to potential contraindications with the ciprofloxacin of the medical order. In the same example, the medical order for ciprofloxacin may automatically populate the workflow with an additional related task that specifies a healthcare worker collect a urine sample and another related task that specifies for a lab technician to perform a kidney function test on the urine sample, due to potential adverse effects of the ciprofloxacin of the medical order.

In embodiments, the indication of the task includes a current form of a medical agent to be administered to the patient by a healthcare worker to whom the task was assigned. Form generally refers to a form in which the medical agent may be administered to a patient. Exemplary forms include a tablet, a caplet, a capsule, an orally disintegrating tablet, a lozenge, a gel tablet, a sustained release pill, an extended release pill, an osmotic controlled release tablet, a solution, a liquid, a syrup, an intravenous injection, an intramuscular injection, a subcutaneous injection, an inhalant, an aerosol, a vaporizer, a nebulizer, a nasal spray, a cream, an ointment, a topical gel, a dermal patch, a transdermal patch, a transdermal spray, ear drops, eye drops, an epidural injection, an intrathecal injection, a suppository, and a pessary. In further embodiments, form may also indicate a route of administration of the medical agent. For example, routes of administration might include by mouth, by eye, by ear, by nose, by injection, by intravenous solution, by transdermal patch, an infusion, and the like. As used herein, “current” form refers to a form of the medical agent which a healthcare worker seeks to administer to the patient in order to complete the task. For example, when a floor nurse scans packaging or a label of an intravenous solution for lorazepam which the floor nurse intends to administer to patient D, an indication of the task includes the current form. In this example, the current form is “intravenous solution” or a parsing thereof, “lorazepam” is the therapeutic agent. Thus, the current form refers to the form of the medical agent that the clinician who is tasked to administer the medical agent intends to administer to the patient.

The indication of the task associated with the medical order for a patient may be received by a computer server, in some embodiments. In further embodiments, a computer server receives the indication from a remote computing device in a healthcare information and management system, such as that shown in FIG. 1. The indication may include additional information such as the time the medical order is placed, a clinician associated with the medical order placement, a healthcare worker associated with the performance of the task, a patient identifier, a date and/or time of performance of a task, and/or the like.

At block 204, an initial form that was previously assigned to the medical order for the patient is identified. In some embodiments, when the medical order is initially entered by a clinician into the workflow, a form may be assigned to a medical agent that corresponds to the medical order. This is the “initial” form, as referred to herein. In another embodiment, a form is assigned manually by a pharmacist when the medical order reaches the pharmacist in a workflow, for example, to verify and fill a prescription corresponding to the medical order. Generally, the initial form is a form that was previously assigned to a medical agent of the medical order prior to receipt of an indication of the task, which includes the current form. In some embodiments, the initial form is manually selected or entered by a clinician at the time the medical order is entered. In other embodiments, the initial form is automatically assigned to the medical order by the healthcare information and management system. In another embodiment, the initial form is assigned by a pharmacist who receives and reviews the medical order as received on behalf of a clinician. In yet another embodiment, the pharmacist may alter or change the initial form associated with the medical order to reflect a new initial form that is to be associated with the medical order for any subsequent, remaining tasks of the workflow.

Next, it is determined whether the current form of the medical agent is compatible with the initial form, shown at block 206. In embodiments, a computer server may reference a computer store in making said determination. In further embodiments, a computer server may access a compatibility index in a computer store when making said determination. It will be apparent to those in the art that when the current form is an exact match of the initial form, that no compatibility determination may be needed, in some embodiments. Alternatively, it will be understood by those in the art that when the current form is the same as the initial form, it is determined that the current form is compatible with the initial form, in some embodiments. Accordingly, a compatibility determination is generally performed when a current form is not an exact match, is a mismatch, or is different than the initial form.

Whether mismatched forms of the same medical agent are compatible may be determined based on any number of factors. For example, forms may be determined to be compatible based on backend matching logic. As used herein, backend logic refers to computer-based matching logic that is hosted or located at a computer server, for example, and accessed by remote computing devises. In order to resolve compatibility, the backend logic may parse information included in the indication of the task. For example, when a current form is identified and communicated, for example, by scanning a machine-readable identifier, the current form may include the term “tablet” or portion of a term “TAB” as an indicator of a tablet form. Backend logic may reference and utilize a compatibility index in a computer store to determine that “TAB” is also compatible with the identified initial form “CAP” and “caplet” which are indicators of a caplet form. In another example, the indication of the task specifies that the current form includes terms “IR” and “TAB” which are indicators of an immediate release form of a medical agent. Backend logic may reference and utilize a compatibility index in a computer store to determine that “IR” is not compatible with the identified initial form “XR,” an indicator for an extended release form of the medical agent.

Other factors affecting form compatibility may include a rate of release of an active ingredient of a medical agent, an absorption efficacy of a form, an absorption rate of a form, a timed release mechanism of the medical agent, and like. It will be understood that these are examples and should not be construed as limiting, as other medical agent properties and form characteristics are contemplated to be within the scope of the invention, as factors in determining compatibility of different forms.

In another example, a buccal tablet that dissolves when held between the cheek and gum of a patient for direct absorption of the medical agent may be compatible with a sublingual tablet that dissolves when held beneath the tongue for direct absorption of the same medical agent, where the buccal tablet and sublingual tablet are each configured to dissolve orally. In a typical clinical setting not implementing the current embodiment, a current buccal form may register as a non-match when the initial form assigned includes a sublingual form and error would halt the workflow. However, in the embodiment of the method 200 herein, a current buccal form may register as compatible with the initial sublingual form, albeit the two forms are not exact matches.

In another example, delivery of a medical agent by a transdermal patch may be compatible with delivery of the same medical agent by an oral solution. Determining that a transdermal patch of a medical agent is compatible with an oral solution of the same medical agent may be useful where a clinician, in attempting to perform a task by administering a form of the medical agent, is alerted to the fact the patient is experiencing nausea and vomiting. Therefore, rather than administering the medical agent using the initial oral solution form and risking partial or complete loss of dosage due to vomiting, the clinician may determine that the medical agent may be administered by a transdermal patch form. As such, when the clinician scans the current transdermal patch form of the medical agent, it may be determined that the current transdermal patch form is compatible with an initial oral solution form. When it is determined that the current and initial forms are compatible, the clinician may electronically document the completion of the task using the current transdermal patch form of the medical agent. In this way, patient care may be optimized at the bedside, for example.

In another example, delivery of a medical agent using a drug-in-adhesive transdermal patch may be determined to be compatible with delivery of the same medical agent using a monolithic transdermal patch. Further, delivery of the medical agent using a drug-in-adhesive transdermal patch may also be compatible with delivery of the same medical agent using a reservoir type transdermal patch. It will be understood, however, that a monolithic transdermal patch may not be compatible with a reservoir type transdermal patch, in some clinical circumstances.

In further embodiments, when it is determined that the current form is compatible with the initial form, the clinician is allowed to proceed with task completion. In some embodiments, the compatibility determination is transparent, such that a clinician is never notified of the determination unless or until non-compatibility is determined. In addition, other safety checks may be addressed and evaluated concurrently with the compatibility determination. Alternatively, some safety checks may be addressed before or after the compatibility determination. Exemplary safety checks, concurrent or otherwise, may include verification that the patient identified by a scanned machine-readable identifier matches a patient corresponding to the medical order, verification that the dosage indicated at a point of delivery (e.g., scanned by a clinician for administration to a patient) matches a dosage specified in the medical order, verification that the route of administration indicated at a point of delivery corresponds to a directive regarding route of administration indicated by the medical order, and verification that the date and time at the point of delivery correspond to a date and time indicated by the medical order. As such, multiple safety checks may be performed contemporaneously (i.e., close in time) with the compatibility determination and/or task completion of a medical order.

Continuing, when it is determined that that the initial form is not compatible with the current form, an error is issued, as illustrated at block 208. In embodiments, a server generates an error and issues the error for communication to a remote device, such as a scanning device. In some embodiments, the error is issued and communicated to a remote device from which the indication of the task was received, or at which the indication of the task originated. For example, the error may be issued and communicated, via the healthcare information and management system, to a scanning device from which the current form of a medical agent was entered (e.g., scanned) for the purposes of completion of a task. As such, the error may surface on the scanning device via a user interface such as a display or sound notification. The error may communicate a warning message that the current form is not correct or is not compatible with an initial form associated with the medical order. The error may be a caution indicator surfaced at a remote device to inform a clinician that the task cannot be completed at that time, in some embodiments. Additionally or alternatively, the error may be logged electronically in the healthcare information and management system with a time and date corresponding to the compatibility determination. Such an electronic log of the error event or conflict may be reviewed or audited at a later time, for example, in some embodiments. In another embodiment, the error may communicate that the clinician should manually enter, manually chart, or manually log the task if the clinician wishes to proceed with administering the current form of the medical agent. In other embodiments, such as embodiments wherein it is determined that that the initial form is, in practice, compatible with the current form, the determination that two or more forms are compatible may be logged electronically in the healthcare information and management system. The electronic log of a compatibility determination may include a date, a time, a clinician identifier, and other information corresponding to form compatibility and a medical order, in some embodiments. Electronic logs of compatibility determinations and/or non-compatibility determinations may be utilized for auditing and reviewing clinician performance, patient care, and/or compliance with protocols or professional standards, for example. It will be understood by those in the art that the examples set forth herein are merely illustrative in nature and should not be construed as limiting.

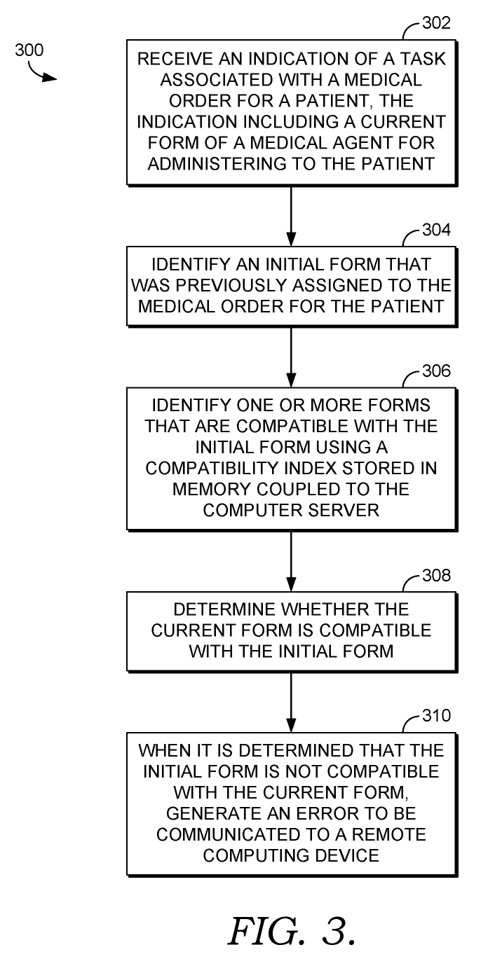

At FIG. 3, a computerized method 300 for assessing compatibility between medical agent forms during medical order task performance in a clinical setting is provided. Generally, the method 300 may be performed at a computer server in a healthcare information system. At block 302, the method includes receiving an indication of a task associated with a medical order for a patient. In embodiments, the indication includes a current form of a medical agent for administering to the patient. And at block 304, an initial form that was previously assigned to the medical order for the patient is identified by the method 300. Continuing, the method 300 next identifies one or more forms that are compatible with the initial form using a compatibility index stored in memory coupled to the computer server, shown at block 306. And, at block 308, it is determined whether the current form is compatible with the initial form. The method 300 further comprises generating an error to be communicated to a remote computing device when it is determined that the initial form is not compatible with the current form.

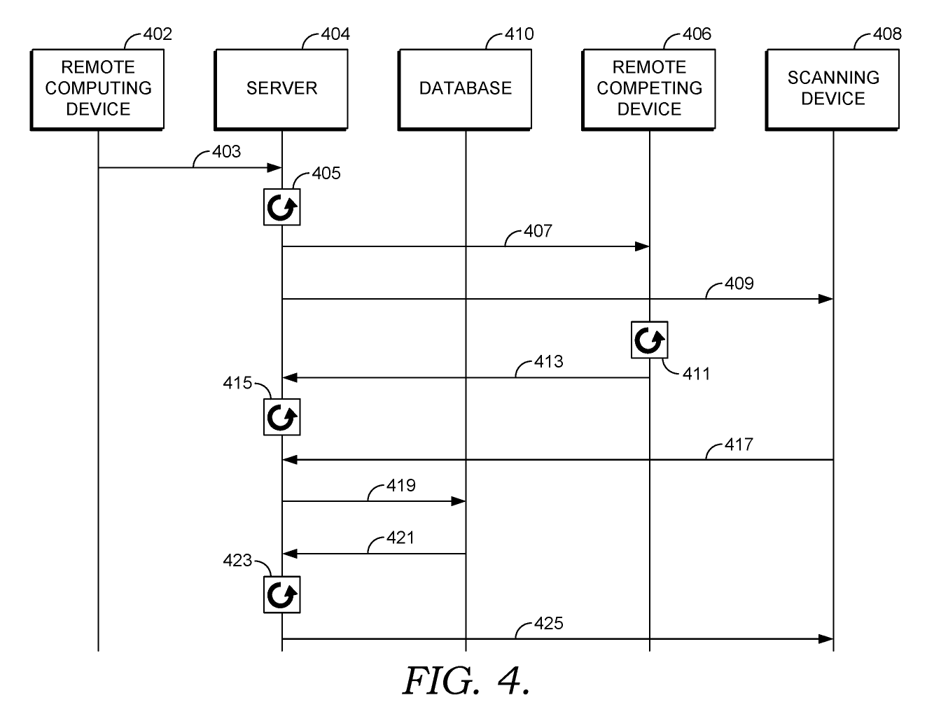

With reference to FIG. 4, diagram showing component interactions in a healthcare information and management system in accordance with an embodiment of the present invention is provided. At FIG. 4, a first remote computing device 402 communicates information 403 to a server 404. The information generally includes a medical order, as entered by a clinician at the remote computing device 402. The first remote computing device 402 is communicatively coupled to the server 404 in a healthcare information and management system, in embodiments. Using the medical order, or in response to receipt thereof, the server then populates a workflow 405 with tasks to be performed by one or more clinicians.

The server 404 may communicate a first task 407 to a second remote computing device 406 in the healthcare information and management system. Generally, the first task 407 is related to a medical order and/or information 403 received by the server 404. The first task 407 may be a directive for a clinician associated with the second remote computing device 406, and/or a location of said device 406, to perform. For example, the first task 407 may instruct a pharmacist, via the second computing device 406 located at a pharmacy, to verify and fill a prescription for a medical agent that is specified by or related to a medical order received by the server 404 via the first remote computing device 402. Additionally, the server 404 may send another second task 409 to a third remote computing device, such as scanning device 408. The second task 409 may instruct a different clinician to perform another task. Generally, the tasks 407 and 409 are specific to the clinician for which the task is intended, for example, clinician type (e.g., physician, pharmacist, floor nurse, charge nurse, laboratory technician), practice area (e.g., neurology, pediatrics, urology, internal medicine), location in a facility (e.g., fourth floor, sixth floor east, emergency room, nephrology laboratory, internal medicine clinic, neonatal intensive care unit), and the like. The server 404 may continue to populate the workflow over a period of time, and/or update tasks within the workflow at any time, as will be understood.

Upon receiving the first task 407, the second remote computing device 406 may receive input from a user, such as a clinician. For example, a pharmacist may verify a medical order by selecting a medical agent and/or a form thereof. As such, the second remote computing device 406 may receive an indication from a user that the first task 407 has been completed 411. Additionally or alternatively, the second remote computing device 406 may receive an indication from a user that a particular form of a medical agent has been selected for or otherwise assigned to another task in the workflow, such as second task 409, regarding the medical order and/or information 403. Upon processing user-provided input regarding the first task 407, the second remote computing device 406 may communicate an indication of the completion 413 of the first task 407 to the server 404. The server 404 may then update the workflow 415 to reflect the completion 413 of the first task 407. For example, the server 404 may update the workflow 415 to reflect an assigned form of a medical agent regarding the medical order.

Continuing, the scanning device 408 may also communicate information 417 regarding the second task 409 to the server 404. For example, the scanning device 408 may send scanned information 417 to the sever 404 for verification of information therein. The information 417 communicated may include a medical agent and a form of a medical agent to be administered to a patient in an attempt to complete the second task 409, for example. As such, the communicated information 417 may also include a request for the server to perform verification before the second task 409 is initiated, performed, or completed by a clinician. Exemplary information may be communicated to the server 404 such that the server 404 may verify patient identity, a medical agent to be administered to the identified patient, a dosage of the medical agent to be administered to the patient, a route of administration of said medical agent, and a date and time when the medical agent is to be administered to the patient.

The server, 404, upon receipt of the information 417 communicated from the scanning device 408, may attempt to verify the information. For example, the server 404 may query 419 a database 410 in order to verify form compatibility of a form of a medical agent specified in the information 417 received from the scanning device 408. The server 404 may query 419 the database 410 using a form of a medical agent that was provided in the information 417 received from the scanning device 408, for example. The database 410 may return form compatibility information 421 to the server. In this way, the server 404 may verify that a form of the medical agent provided in the information 417 received from the scanning device 408 is or is not compatible with an assigned medical form already associated with the workflow for the medical order. During verification and analysis, the server 404 may utilize one or more of the following: a medical form specified in the information 403 received from the first remote computing device 402; a medical form provided in the information 413 received from the second remote computing device 406; a medical form initially assigned during the population of the workflow 405; and/or a medical form provided in the information 417 received from the scanning device 408. As form compatibility has been previously described herein, further discussion is not provided for brevity.

Continuing with FIG. 4, in embodiments wherein two or more forms of a medical agent are not compatible, the server 404 may generate an error. As previously described herein, the server 404 may issue a warning message that the forms at issue are incompatible, and the like. The server 404 may communicate the error 425 to the scanning device 408 when forms are incompatible. In embodiments wherein it is determined that the forms at issue are compatible, the server 404 may not issue an error message, but rather, the workflow may continue transparently, such that a user of the scanning device 408 is unaware of the form compatibility analysis performed at the server 404. In such embodiments, the server 404 may perform addition analysis, such as checking for adverse medical agent interactions and the like. In some embodiments, the server 404 may log an instance when an error is generated, and/or may log an instance when no error is generated, to monitor and track form compatibility information.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A system useful for assessing compatibility between therapeutic agent forms during medical order task performance in a clinical setting, the system comprising:
(a) a computer store containing data, including, for each of a plurality of therapeutic agents, a compatibility index of one or more forms of each of the plurality of therapeutic agents that are compatible; and
(b) a computer server in a healthcare information system, the computer server coupled to the computer store and programmed to:
receive an indication of a task corresponding to a medical order for a patient, wherein the task corresponding to the medical order specifies a current form of a therapeutic agent for administering to the patient;
identify an initial form previously assigned to the medical order for the patient;
determine whether the current form of the therapeutic agent is compatible with the initial form using the compatibility index; and
when it is determined that the current form of the therapeutic agent is not compatible with the initial form, issue an error.

2. The system of claim 1, wherein the computer server further comprises a backend logic programmed to parse a current form of the therapeutic agent.

3. The system of claim 2, where the computer server further comprises another server configured to automatically assign an initial form to one or more medical orders when received by the healthcare information system.

4. The system of claim 1, wherein the computer server further comprises memory configured to store the compatibility index thereon.

5. The system of claim 1, further comprising a remote computing device coupled to the computer server.

6. The system of claim 5, wherein the remote computing device is further configured to:
receive one or more of the medical orders for the patient, as entered by a user-clinician.

7. The system of claim 5, wherein the remote computing device is further configured to:
communicate the indication of the task corresponding to the medical order.

8. The system of claim 5, wherein the remote computing device is a handheld device that is configured to:
receive the error issued via the server.

9. The system of claim 1, wherein the server is further programmed to:
when an error is issued, automatically log the error and information corresponding to the current form as incompatible with the initial form.

10. The system of claim 1, wherein issuing the error comprises communicating the error to a remote computing device from which the indication of the task corresponding to a medical order for a patient was received.

11. One or more computer storage media having computer-usable instructions that, when used by one or more computing devices, cause the one or more computing devices to perform a method for assessing compatibility between therapeutic agent forms during medical order task performance in a clinical setting, the method comprising:
receiving an indication of a task associated with a medical order for a patient, the indication including a current form of a medical agent for administering to the patient;
identifying an initial form that was previously assigned to the medical order for the patient;
determining whether the current form of the medical agent is compatible with the initial form; and
when it is determined that that the initial form is not compatible with the current form, issuing an error.

12. The one or more computer storage media of claim 11, further comprising:
in response to receiving a medical order, assigning the initial form to the medical order.

13. The one or more computer storage media of claim 11, further comprising:
receiving, from a remote computing device, the initial form as assigned by a user-clinician.

14. The one or more computer storage media of claim 11, wherein determining whether the current form of the medical agent is compatible with the initial form further comprises:
querying a compatibility index that specifies compatibility across one or more forms of each of a plurality of medical agents.

15. The one or more computer storage media of claim 11, wherein determining whether the current form of the medical agent is compatible with the initial form further comprises:
updating a compatibility index in a computer store to reflect that one or more forms of the medical agent are compatible.

16. A computerized method for assessing compatibility between medical agent forms during medical order task performance in a clinical setting, the method comprising:
at a computer server in a healthcare information system:
receiving an indication of a task associated with a medical order for a patient, the indication including a current form of a medical agent for administering to the patient;
identifying an initial form that was previously assigned to the medical order for the patient;
identifying one or more forms that are compatible with the initial form using a compatibility index stored in memory coupled to the computer server;
determining whether the current form is compatible with the initial form; and
when it is determined that the initial form is not compatible with the current form, generating an error to be communicated to a remote computing device.

17. The method of claim 16, further comprising:
receiving the medical order from a remote computing device, and
assigning the initial form to the medical order.

18. The method of claim 16, further comprising:
when it is determined that the initial form is compatible with the current form, using the medical agent to identify one or more potential adverse interactions with another medical agent associated with the patient.

19. The method of claim 16, further comprising:
receiving an indication from a user-clinician at a remote computing device that the initial form is compatible with the current form.

20. The method of claim 19, further comprising:
updating a compatibility index in a computer store to reflect that the initial form is compatible with the current form, based on the indication received from the user-clinician.
